(19) United States
(12) Patent Application Publication
(10) Pub. No.: US 2023/0237857 A1
(43) Pub. Date: Jul. 27, 2023

(54) System and Method for Scheduling Vehicle Maintenance and Service

(71) Applicant: Scope Technologies Holdings Limited, Tortola (VG)

(72) Inventor: Samuel Lavie, Johannesburg (ZA)

(21) Appl. No.: 18/120,817

(22) Filed: Mar. 13, 2023

Related U.S. Application Data
(63) Continuation of application No. 16/703,442, filed on Dec. 4, 2019, now abandoned.
Application No. 16/703,442 is a continuation of application No. 14/935,828, filed on Nov. 9, 2015, now abandoned.
(60) Provisional application No. 62/077,245, filed on Nov. 9, 2014.

(51) Int. Cl. G07C 5/08; G07C 5/00; G06Q 10/00

(52) U.S. Cl. CPC G07C 5/08; G07C 5/008; G06Q 10/00; G07C 5/0808

(57) ABSTRACT

Described herein is a system and method for predicting when repair and maintenance needs to be performed on a vehicle. The estimates can be based on one or more of in-vehicle sensor measurements during vehicle usage, external observations such as weather and traffic and road conditions and manually or digitally input maintenance and service reports. The gathered information is compared to information in a database from historical maintenance and service and the resulting damage and costs for those. The information is classified by the type of vehicle and the age and usage of the vehicle. Maintaining and refreshing the information and predictive models in the system is also part of the invention.

### RELATED APPLICATIONS

This application is a continuation of U.S. Nonprovisional patent application Ser. No. 16/703,442, filed on Dec. 4, 2019, which application is a continuation of U.S. Nonprovisional patent application Ser. No. 14/935,828, filed on Nov. 9, 2015, entitled “System and Method for Scheduling Vehicle Maintenance and Service”, which application claims priority to U.S. Provisional Patent Application No. 62/077,245, entitled “System and Method for Predicting and Scheduling Vehicle Maintenance and Repair”, filed on Nov. 9, 2014. Each of these applications are incorporated by reference in its entirety.

The following applications (also showing filing dates) are related to this application and are herein incorporated by reference: U.S. 62/109,434 Jan. 29, 2015; PCTIB2014001656 Jul. 27, 2014; U.S. 61/968,904 Mar. 21, 2014; U.S. Ser. No. 14/517,543 Oct. 17, 2014; Ser. No. 14/131,7624 Jun. 27, 2014; U.S. Ser. No. 13/860,284 Apr. 10, 2013; EP 2795562 Dec. 21, 2012; Ser. No. 13/679,771 Nov. 16, 2012; U.S. Ser. No. 13/679,749 Nov. 16, 2012; U.S. Ser. No. 13/679,722 Nov. 16, 2012; U.S. 62/077,245 Nov. 9, 2014.

### FIELD OF INVENTION

Embodiments of the invention are generally related to systems and methods to predict vehicle part longevity based on historical records and sensor output. Another object of the invention is to schedule maintenance to reduce catastrophic failure and maximize uptime of vehicles. In an embodiment, the system monitors in-vehicle sensor output acquired during vehicle operation, and then compares that output with a database of information on previous similar vehicles operating under similar conditions to predict parts ware. In other embodiments, the predictions are used to manage parts inventories for a fleet of vehicles and further to forecast the need for parts, and to automatically order and distribute parts where the need is anticipated.

### BACKGROUND

Standard methods of dealing with replacement of warn parts is to either replace them when they fail or replace or service them based on mileage of the vehicle and by following the manufacturer's recommendations for maintenance.

Current state of the art is to manually record when parts are replaced relative to the mileage of the vehicle which is time consuming and requires input from several individuals including drivers, mechanics and parts distributors.

Of necessity, manufacturers' recommendations for replacement and/or maintenance of parts will be conservative, both because the manufacturer will not be aware of the driving conditions that a vehicle will be subjected to and also because they generate more revenue when they sell more parts.

Parts inventories both at retail outlets and distribution centers are not necessarily in sync with the need for the parts, but rather a stock of parts are simply kept on hand, or at best as per manufacturer recommendation.

### SUMMARY

In an embodiment of this invention, it is an object to create a better method of predicting parts longevity as well as predicting required maintenance of vehicles and vehicle parts.

The above may be performed by acquiring information about the vehicle usage from a variety of sources and comparing that information to the same information compiled from many other similar vehicle used in similar conditions. Estimates of parts longevity and required maintenance are then based on the comparisons.

In some embodiments, there is a link between the system that performs the assessments and provides recommendations for replacement, maintenance and repair services. Parts warehouses can also be linked in order to determine the availability of parts and approximate time of repair and also to order and stock parts based on anticipated demand.

In an embodiment, parts are ordered for local distribution centers and retail outlets based on the predicted demand for each part.

### Glossary

Memory: a storage device for digital information. The terms is generically used to refer to both volatile and non-volatile memory and both solid-state and movable media unless otherwise specified. In relation to database storage, the requirement of the memory is that it be accessible by a processor to retrieve records and also to be able to write records to the memory.

Maintenance Report: a document or report (either hardcopy or online) that results from analysis of information relating to a vehicle operation, that schedules maintenance and repairs that are required to keep a vehicle in peak operating condition.

In-vehicle: Refers to anything that is part of the vehicle or within or attached to the vehicle.

Sensors: measurement devices which measure parameters that are directly or indirectly related to the amount and extent of maintenance and/or repair needed to keep a vehicle in operating condition. Sensors could be in-vehicle—either part of the vehicle or an after-market attachment to the vehicle such as a fleet management system or as part of a mobile device within the vehicle such as the sensors in a mobile phone—like accelerometers or gyroscopes. Sensors may also be outside the vehicle such as roadside traffic counters in the vicinity of the vehicle, weather stations, and satellite or airborne based sensor such as LIDAR. External sensors that can provide information about the condition of pavement, weather, freeze thaw conditions or the like are included.

Transceiver: A means to communicate between two devices whether it be wired or wireless. Examples are two-way radios, mobile phones, wired modems and the like.

Location: where an object is relative to a reference frame. The location of a vehicle is some embodiments is relative to the earth in terms of a coordinate system such as latitude and longitude (and perhaps elevation).

Vehicle: any object capable of moving material or people. This includes cars, trucks, boats, airplanes, construction equipment and the like.

External Observations: See the definition of sensors above for examples of observations that can come from outside the vehicle. Source for this information can also be from web services, for example weather data, or traffic information that is a feed coming in from a FM sideband via an FM receiver.

Reference (for a database): an index or other attribute that can be used to select database records of interest by querying using the index or attribute. For example reference for accident information could be: location, time, time of day, time of week; make of vehicle, year of vehicle (or Vehicle Identification Number), weather conditions, location of impact (zone on the car), direction of impact, force of impact and the like.

Normalized: transforming data from a variety of sources into the same units, in the same frame of reference.

Historical Maintenance Database: a database or collection of linked databases containing information that is related, for example, to parts failure and replacement, parts wear, and accident events where damage occurs. All information is cross referenced so that it can be used for statistical analysis of accidents, parts wear and the cost of repair resulting from the accident or wear.

Cross-referenced: With respect to a database, one entry can be queried as to its relationship to another if there is some type of relationship between the two. For example, a certain model of water pump produced by General Motors may have been used in a variety of car models over a variety of model years, so the part number for the water pump will be cross referenced to vehicle model number, year, and engine type. Also note these parameters may not be sufficient information, because a part used may change mid-model year. For example a wheel type might not be compatible halfway through a model year because the lug spacing was changed for safety reasons. In this case, the wheel would have to be referenced to the specific Vehicle Identification Number (VIN) which could be further cross referenced to a linked database containing more detailed information.

Confidence Interval: One method of expressing the probability that an outcome will be observed to happen within a specific range for a given set of circumstances. For example the probability that the water pump will have to be replaced for after 100,000 miles is 95 percent for a Ford Focus and 92 percent for a BMW 928i.

Bias: Tendency to make certain observations more than others.

### BRIEF DESCRIPTION OF THE FIGURES

FIG. 1 is a system overview for developing a vehicle maintenance and service prediction system.

FIG. 2 depicts how the system is used.

FIG. 3 is a sample of how vehicle faults are indicated in a diagnostic trouble codes (DTC).

FIG. 4 is a sample of a maintenance log for a vehicle.

FIG. 5 is a vehicle service log.

### DETAILED DESCRIPTION

### Overview

In embodiments of the present invention, one of the goals is to predict the minimal maintenance needed to be performed to keep a vehicle at peak or acceptable operating conditions. It is desirable to extend the maintenance periods over manufacturer specifications if possible and safe. Maintenance required is a function, for example, of what kind of vehicle was being driven, the age and condition of the vehicle, the location, road or terrain conditions driven over and previous maintenance conducted on the vehicle. The cost of maintenance, for example, is a function of the location of the maintenance (regional variation in parts costs and labor costs), whether the maintenance is scheduled and the parts that need to be replaced.

Maintenance or service must be classified or grouped together, so that information based on observed parameters recorded in an historical maintenance and service database can be used to predict and assess maintenance and service requirements for vehicle in operation currently.

It is further object of this invention to both stock and reserve parts and consumables that are anticipated to be needed based on monitoring of vehicle usage and prediction of maintenance and service requirements.

Another object of the invention is to schedule time for maintenance and service with qualified technicians.

It is an object of the invention to continually update the database of maintenance and service records with information that can be better utilized to predict future maintenance and service assessments.

It is an object of the present to monitor driving performance and relate this to vehicle maintenance and service requirements.

It is an object of the present invention to estimate when the cost of maintenance and service becomes prohibitively expensive and the vehicle should be retired.

### System Designs

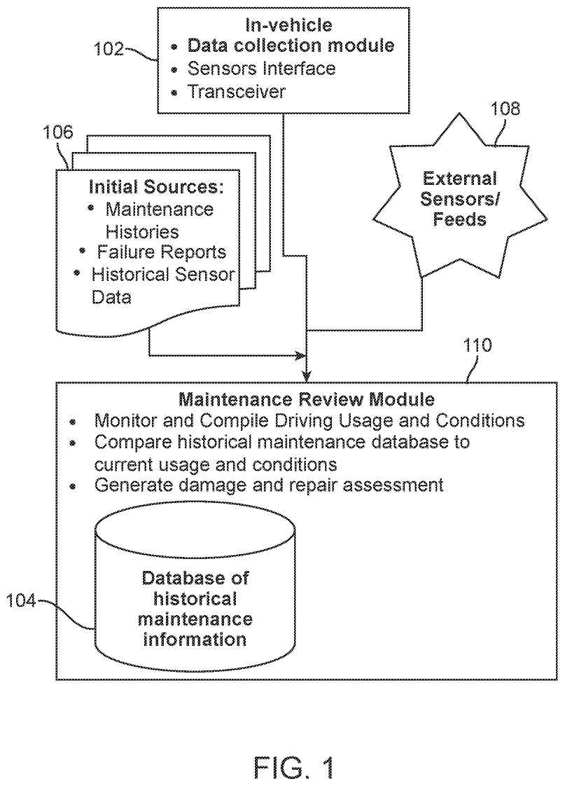

Systems designed to assess and predict maintenance and service resulting from normal usage of a vehicle can come in a variety of configurations. In an embodiment, FIG. 1 depicts how a system for prediction is developed. Primary components are:
In-vehicle data collection module 102
Database of historical maintenance information 104
Maintenance review module 110

When initially constructing the system, a database 104 that is part of the maintenance review module 110 must be created. Multiple sources of information 106 are used which include vehicle mileage records, driving condition logs, in-vehicle sensor logs, maintenance reports from repair shops, fleet management records, failure reports, repair invoices, parts lists, and the like. The database 104 may contain raw data, maintenance predictive functions, and metadata (for example, error estimates on the validity of the data). The database 104 also contains derivative products of the sensor data such as categorized or normalized versions of the input data and/or functions for which to categorize or normalize each type of input. Once an initial database is configured and populated, statistical correlations are formulated based on the historic information in order to develop predictive model for required maintenance for a given vehicle, or class of vehicles or particular components common to numerous types of vehicles. In operation, an in-vehicle data collection model 102 comprises a sensor interface capable of receiving and storing data from sensors within the vehicle or part of the vehicle. The data collection module can communicate with a maintenance review module 110 which can either be located in the vehicle or remote to the vehicle. Communication can be either by wired or wireless methods. In addition the maintenance review module 110 can acquire information from external sensors networks such as weather feeds and traffic. Note this function could alternatively take place in the in-vehicle data collection module 102. The maintenance review module 110 receives all the pertinent information concerning vehicle usage and driving conditions, categorizes the information; inputs the information into a predictive function (statistical correlation), then predicts required maintenance and service and optionally, the anticipated cost. At least one of the raw data and derivatives of the data, such as normalized data, categorized data, and error estimates are then transmitted a historical database 104 to be used in updating the predictive functions. Later information from repair and service facilities are also input into the database and are used to validate the prediction and improve the prediction going forward (not shown).

### General Usage

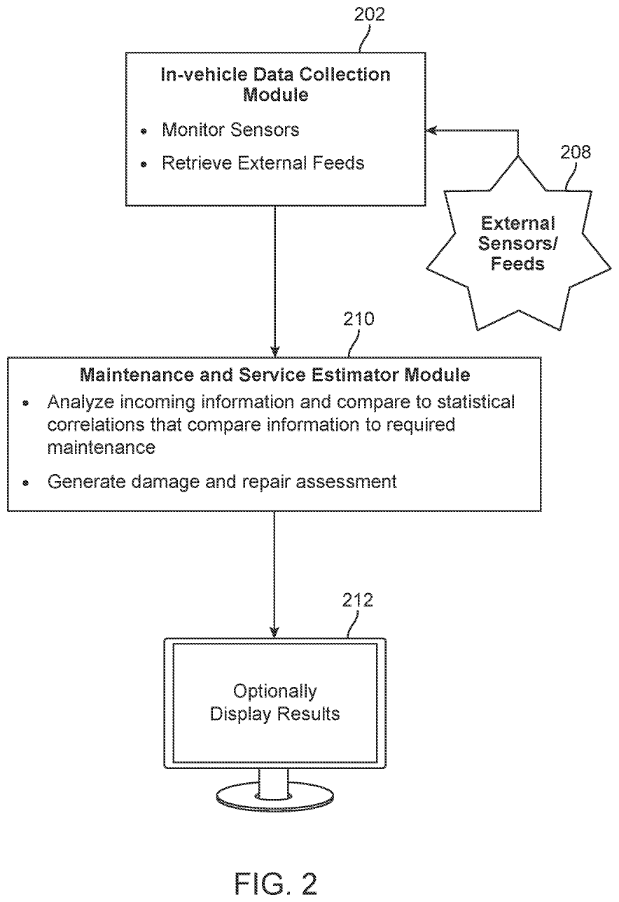

In an embodiment, as shown in FIG. 2, a vehicle is equipped with a in-vehicle data communication module 202, and a maintenance and service estimator module 210. Optionally the in-vehicle data communication module 202 may be in communication with external services and/or feeds 208 that would provide information such as weather (that might affect driving conditions) and traffic. Information travels from the data communication model 202 to the maintenance and service estimator module 210 which contains the statistical correlations or predictive functions which relate the gathered information to anticipated maintenance and service. An analysis continually happens within the estimator module 210 and if a correlation is found between the sensor information and required maintenance or repair, then the event is noted and optionally displayed 212 to the driver or transmitted to another device or server (such as a fleet manager's server (not shown).

### Communication Protocols

Referring to the schematic of a system FIG. 1, the information that is either stored or generated in the various components needs to be communicated to other modules of the system. Sensors need to communicate with data collection module 102. If the sensors are part of the vehicle (oxygen sensors, temperature sensors—for example) then communication would typically happened using the car's system bus which could be either conventionally wired or based on fiber optics provided the data collection module 102 was integral to the vehicle electronics. If the data collection module 102 was an add-on product or consists of software running on a mobile device within the car, then communication with the integral vehicle sensor may be by using an interface that can read on-board diagnostic (OBD II) codes by interfacing with a vehicle portal designed for external communications.

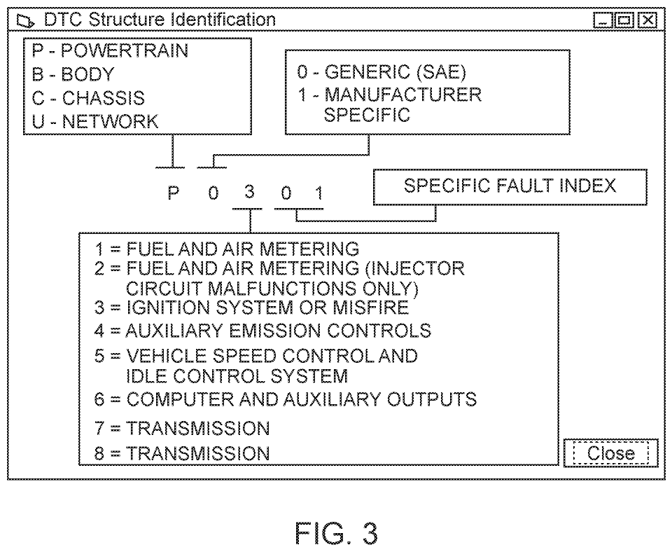

Another type of code that is somewhat standardized for vehicle diagnostics is the diagnostic trouble codes (DTC). FIG. 3 describes how a typical DTC is structured.

Many vehicles have Bluetooth or similar short range wireless protocol communication modules and can transmit information such as DTC codes to nearby devices. Longer range telematics devices that use, for example, mobile phone communication methods, also exist that can transmit DTC codes or similar code to a central location

If the vehicle data collection module has software running on a general purpose computing device such as a mobile phone, the phone or other device could be plugged into the vehicle using a wired means such as a Universal Serial Bus (USB) or short range wireless such as Bluetooth.

Sensor that are part of the mobile device can also be considered in-vehicle sensors provided the device is in or attached to the vehicle. These types of sensors can include gyroscopes, accelerometers, altimeters and GPS, for example. Communication with these sensors would be over the data bus of the portable device.

External data coming from services or external sensors can be communicated through an internet connection, FM sidebands (such as traffic messaging channel information TMC).

### Database Design and Input Normalization

In embodiments of this invention, vehicle maintenance and service requirements are predicted by comparing the observed conditions that occur during vehicle operation over time with similar observed conditions for similarly classed vehicle used in similar conditions stored in a historical vehicle maintenance database. Algorithms are developed to classify each maintenance or service event as succinctly as possible, given the available data, such that when the conditions requiring maintenance or service for a vehicle in use match a classification, this can be used with a degree of certainty, to predict resulting maintenance required and the parts and services necessary to affect the maintenance.
In an embodiment, the observed conditions of interest during vehicle operation include:
Specific type of vehicle, including make, year, model, weight and options
Condition of the vehicle (prior damage, corrosion, state of repair)
Maintenance and Repair History
Accident History
Locale of vehicle operation (for determination of regional variable costs)
Environmental factors (weather, road conditions) during operation

Raw data that may be used to predict maintenance and service needed can come from a plurality of sources. Sources include:
In-vehicle Sensors
Accelerometer to measure starting and stopping, rapid turning
ABS sensors to detect when slippery conditions occur
Gyroscope to erratic driving patterns
GPS for speed and direction of travel
Seatbelt sensors
Engine sensors such as oxygen, rpm, pollution control, temperature, etc
External Sensors
Weather from web services
Traffic information from web services or FM sideband (Traffic Messaging Channel)
Road Condition Information from web-sources such as highway departments
Other means of collecting information
Fleet Maintenance Reports (subsequently manually entered into the system database by manual entry using a computer interface application
Repair Shop Invoices
GIS information (speed limits where traveled and roads traveled)

Note that the historical maintenance and repair “database” may be distributed, so that, for example, the predictive function may be in the vehicle and the historical raw data may be on a central server.

When initially building a historical vehicle maintenance and service database, it is likely that there will be a mix of more qualitative data, for example from manually entered fleet maintenance records and repair shop invoices and quantitative data, for example, from in-vehicle sensors. As such there is a subjective element in the reporting and the likelihood of human error will reduce the quality of the manually entered data and therefore if the manually entered data makes up the bulk of the available information, the error in prediction of maintenance will be greater.

In addition, since much of qualitative information would have initially have been manually entered on a piece of paper, there will also be transcription errors regardless of whether the information is manually input into the database by a human or if the information is machine input using optical character recognition and algorithmic processing of the text.

Available information to input into the database will change with time. As more information of a quantitative nature or more precise, accurate and with less bias information becomes available, older more qualitative data will be replaced and the resulting predictive model or associated statistics will be updated to reflect the new data.

There are at least two methods to deal with disparate data (differing quality and precision) that can be used to model an event: 1) You can make the initial predictive model imprecise, for example, base maintenance schedules on vehicle mileage only; and 2) you could structure the database to support a more precise model, but indicate that initial predictions will have low accuracy—for example, the model could support maintenance as a function of both mileage and conditions that the vehicle was subjected to, but for the bulk of the information input into the model, median driving conditions would be presumed.

For information from disparate sources to be compared, the information must be normalized, i.e. converted to the same units of measure and be relative to the same reference frame. In addition, the quality and precision of the data must also be evaluated and represented within the database in a normalized fashion. In other words, if for example, one speed is known to be accurate within +/−10 mph, then all speeds in the database should have an error of estimate in mph (as opposed to kph for example).

A probability that a particular type of maintenance will be needed if a series of measured parameters fall within specified ranges is calculated. No two vehicle usage scenarios are alike even if the vehicles are identical, so any prediction will not be 100 percent accurate and it is best to either provide an error of estimate associated with each estimate and/or provide an upper and lower range of when maintenance is required and costs.

If an initial build of a database is created from mostly quantitative data, then it may not be possible to predict specific damage and may only be possible to predict cost of repair, and with a large degree of uncertainty.

If the input data is a mix of in-vehicle sensor data, and manually input qualitative data then, using statistical techniques know in the art, the predictive function can be generated weighting the sensor data more heavily than the qualitative data.

Vehicle sensor data can be used in a variety of ways. For example, accelerometer information can be used to infer road conditions—potholes would generate high frequency vertical acceleration; frequent rapid deceleration in the direction of travel could indicate heavy brake usage. However, there may be no need to determine the underlying cause of acceleration characteristics; it may be found that certain mean levels of acceleration may be predictive of certain types of maintenance requirements regardless of the cause of the acceleration.

Reduction of Information from a Maintenance Log

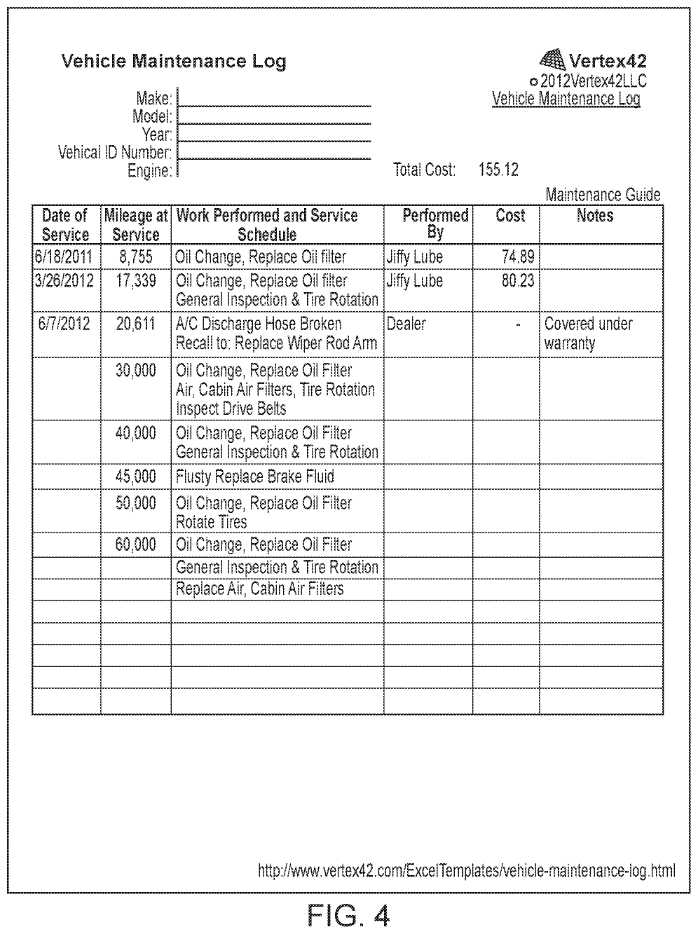

FIG. 4 is an example of a typical maintenance log for a vehicle (from http://www.vertex42.com/ExcelTemplates/vehicle-maintenance-log.html) and it contains several parameters that can be used to provide input for a historical vehicle maintenance database.

Since no two accident reports would be the same, the raw data from many types of accident reports could be entered into a database, then normalized to be used in the predictive model.

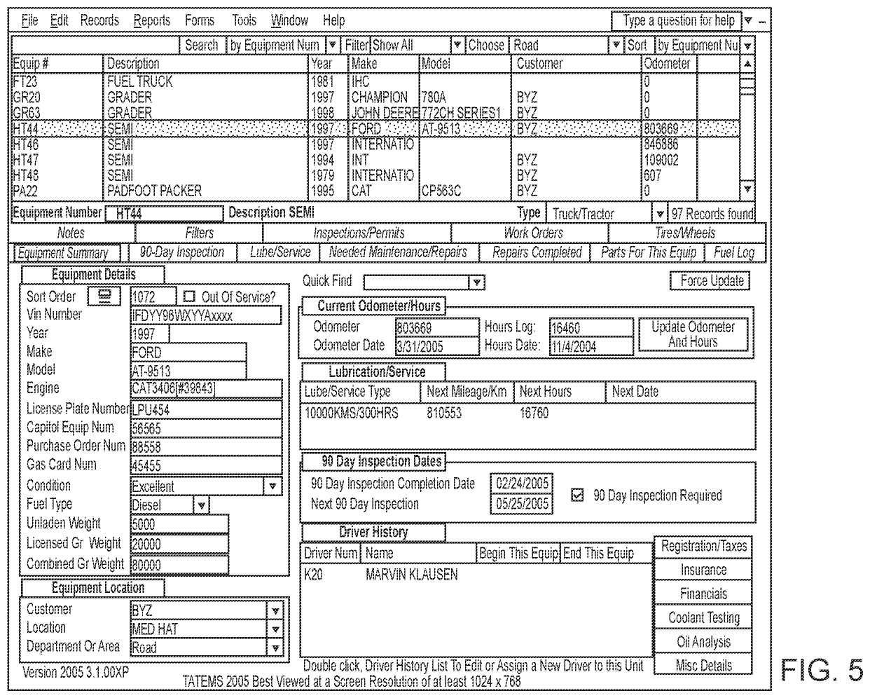

FIG. 5 is an example of a service log for a vehicle (from https://www.google.com/search?g=vehicle+maintenance+recores&newwindow=1&tbm=isch&im gil=790 enLSUV3kTrm%253A%253BKQgRyEjxLSpWmM%253Bhttp%25253A%25252F%2525 2Fwww.organizinghomelife.com%25252Facrhives%25252F4668&source=iu&pf=m&fir=790enL SUV3kTrM%253A%252CKQgRyEJxLSpWmM%252C_&usg=_USKAb2rg7E9-Nj_XrLemFdskjY%3D&biw=2133&bih=1013&dpr=0.9&ved=0CE8Qyjc&ei=u9U_VJnYMISdyQS UjYEo#facrc=_&imgdii=_&imgrc=Mpc35KR61iN2KM%253A%3BGAHT_9w3TAIawM%3Bhttp% 253A%252F%252Fwww.lucid-enterprises.com%252FfrmServices.JPG%3Bhttp%253A%252F%252Fwww.lucid-enterprises.com%252Fcarcar.htm%3B650%3B494).

The process could be as follows:
Create a section of the maintenance and service database to house the data from each particular form
If the form is in paper form, scan in the pages of the report:
   Optically recognize the characters and use search techniques to find headings of interest—for example Vehicle Registration # or Vehicle Year and Vehicle Make.
   Find the value associated with each heading and enter it into the database
   Manually enter other data, for example it may be necessary to interpret the vehicle maintenance that was performed by identifying a circled word that was selected from a list.
If the form is tag based (for example XML) or in other machine readable form:
   Enter the information into the database directly
Obtain information regarding the maintenance task that were performed.
Find statistical relationships between the maintenance records: for example, how long do wheel bearing last on average when driven in New Jersey. Determine the average amount of time a water pump lasts after replacement. Do certain parts from one manufacturer last longer than from another?
Determine a common schema for the predictive database that all the various report structures can be normalized to (see below) and transpose all the data from differing reporting structures to a single format (or at least store functions to normalize all the information).

It should be noted in some embodiments, that more detailed information and information that does not have to be normalized or transposed is preferable. Also information that can be automatically acquired and processed, rather than manually entered is also preferable.

In an embodiment, as more sensor data that can be used to identify maintenance requirements becomes available and is entered into the database, then manually entered and transposed data should be removed from the database and relationships should be re-calculated.

More information on how to build the historical maintenance database and maintaining it for the purpose of categorizing accidents for damage assessment is covered in the related application PCT/IB2014/001656 which is incorporated herein by reference.

### Post Maintenance Information

In the historical vehicle maintenance and service database, there must exist actual maintenance and service records for many vehicles. This information may include:
A listing of parts replaced
Price of labor (preferably broken out by part installed or service performed)
Price of parts
Time between suggested maintenance and it actually occurring
Amount of lost time failures when maintenance suggestions are followed vs when maintenance lags

This information must be associated with the maintenance records for each vehicle and/or sensors information so that correlations can be made.

### Development of the Predictive Model (Statistical Correlation)

Armed with the populated historical vehicle maintenance and service database, predictive functions can be developed. As a starting point, it can be assumed that maintenance is a function of the specific vehicle, and the miles driven. Using this assumption, a query can be run on the database to find the average lifetime (in terms of mileage driven and/or in terms of time since installation) of all parts and determine which parts need to be replaced at what mileage.

Based on the query, a list of database entries should be returned that provide:
Parts that have been replaced and costs
Services that were performed and associated costs

Statistics can then be run on the returned entries: for example, the probability that a particular part needs replacement; the range of costs to purchase and replace that part and so-on.

It may be found that vehicles that have regular preventative maintenance at some interval have less unscheduled maintenance or breakdowns. Alternatively, it may be found that poor or erratic drivers correlate strongly with increased maintenance requirements.

It should be noted if the vehicle maintenance and service database spans large geographic areas and large periods of time, then statistics would need to be adjusted (normalized) for things like present value of money and regional costs differentials.

Depending on how much information is in the database, a query could be very specific, for example, the vehicle model could be simply a Mustang, or the vehicle type could be a Mustang XL. The XL designation could correspond to a different engine model which requires premium gasoline, for example. Data for the XL model could support that using regular gas in this model increases unscheduled maintenance of the fuel system.

Alternatively if there is insufficient information about the Mustang XL in the database, then the query could be for all Mustangs. The returned information could be that it is likely using premium gas results in less unscheduled maintenance for Mustangs in general.

As the amount of information in the database continues to grow and be refined, the relationships for how to predict maintenance may change depending what factors correlate the strongest. It may be found for example, that all variations of the same vehicle require similar maintenance or it may be found that there is significant differences in the amount and extent of maintenance if the same vehicle has a different engine type.

There will be regional variations for cost associated with repairs. Labor charges may be different for service technicians depending on location and also parts availability may vary from place to place. These factors also need to be accounted for in the database.

The database of information needs to contain a statistically significant amount of records that can be related to maintenance and service. In other words, a quality standard need to be set, for example, a standard could be that cost estimates must be valid within plus or minus $50. Therefore there must be enough previous maintenance and service cost data to be able to statistically validate the quality standard for each category.

Determination of Required Maintenance and Service from Sensor Data

What is transmitted to an accident review module depends on how the prediction model is structured. If the model requires raw sensor data as input, then that is what is transmitted. Likewise, if the model requires further categorized data, then that is transmitted. In some embodiments, both raw data and derivative parameters of the raw data are transmitted, even if the raw data is not used in the predictive model. The transmitted raw data can then become part of the raw data in the database, so the predictive model can be updated by including the new raw data in the analysis.

The maintenance review module provided with the input data from the accident, then plugs in the information into the predictive model and returns a prediction.

The prediction will include some or all of the following:
A listing of parts that should be replaced (and optionally probabilities how long a part will last without replacement)
A listing of costs associated with each part (for the region of the accident)
Materials such as oil and antifreeze
The overall cost estimate (may include an upper and lower limit)

In embodiments, additional information is in the database or in a second linked database. This additional information includes an inventory of parts and their location. In addition it may include the workload or backlog of various service technicians and their availability to perform the predicted maintenance or service that need to be done. Additional functionality of the accident review module in embodiments can do one or more of determining the availability of parts, materials and labor and/or request bids for each from providers that have the part/s, materials or time. The review module, in some embodiments will schedule delivery of the parts and service labor based on the availability.

In certain instances, for example, the cost of maintenance and service may be cost prohibitive, given the anticipated life left in the vehicle. The maintenance prediction may exceed a statistically determined threshold value, and this would indicated that the vehicle should be retired (not worth repairing).

### Parts and Materials Inventory

Keeping the proper amount of parts and materials on hand to perform repairs and service is essential. A warehouse does not want more inventory on hand that it needs, but yet wants enough to meet demands. In an embodiment of the present invention, the predictive function based on the historical database can also be used to order and stock appropriate amounts of inventory. Based on the amount of vehicles within a geographic area, and the other factors that go into the predictive model/s, the amount of parts that need to be on hand at any given time can be predicted. The predictions can be tied into automated inventory systems, so that parts and materials can be ordered and transported to facilities (either warehousing or retail or to service centers) without human intervention. Information about how the parts and material are consumed can then be used to validate future versions of the predictive model.

### System Utilization

In an embodiment of the system and method, the prediction of required maintenance and the estimated cost of maintenance is transmitted to the vehicle when service or maintenance is needed. The transmission can occur to either the in-vehicle system or to a mobile device carried by a driver or passenger or directly to a service technician.

If the analysis is transmitted to the car, results can be displayed either graphically and/or in text on a screen in the vehicle—for example, an infotainment system screen.

### Implementations

The present invention may be conveniently implemented using one or more conventional general purpose or specialized digital computers or microprocessors programmed according to the teachings of the present disclosure, or a portable device (e.g., a smartphone, tablet computer, computer or other device), equipped with a data collection and assessment environment, including one or more data collection devices (e.g., accelerometers, GPS) or where the portable device are connected to the data collection devices that are remote to the portable device, that are connected via wired or wireless means. Appropriate software coding can readily be prepared by skilled programmers based on the teachings of the present disclosure, as will be apparent to those skilled in the software art.

In some embodiments, the present invention includes a computer program product which is a non-transitory storage medium (media) having instructions stored thereon/in which can be used to program a computer to perform any of the processes of the present invention. The storage medium can include, but is not limited to, any type of disk including floppy disks, optical discs, DVD, CD-ROMs, micro drive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

### REMARKS

The foregoing description of the present invention has been provided for the purposes of illustration and description. It is not intended to be exhaustive or to limit the invention to the precise forms disclosed. The embodiments were chosen and described in order to best explain the principles of the invention and its practical application, thereby enabling others skilled in the art to understand the invention for various embodiments and with various modifications that are suited to the particular use contemplated. For example, although the illustrations provided herein primarily describe embodiments using vehicles, it will be evident that the techniques described herein can be similarly used with, e.g., trains, ships, airplanes, containers, or other moving equipment, and with other types of data collection devices. It is intended that the scope of the invention be defined by the following claims and their equivalence.

1. A system for scheduling vehicle service and parts requirements within a region comprising:
a plurality of in-vehicle data collection modules disposed in a plurality of vehicles of a common type operating within the region, said collection modules each including one or more sensors configured to collect information concerning operation of said vehicles within the region;
a maintenance and service estimator module comprising a statistical predictive model configured to predict when service and parts are required for vehicles of the common type operating within the region based on vehicle manufacturer maintenance recommendations modified by statistical correlations of historical maintenance and service records, and historical information collected from said collection modules of said vehicles of the common type operated in the region, the historical information including engine sensor data and accelerometer data, when compared with current information collected from the plurality of said data collection modules;
a maintenance and service review module configured to one of determine and revise the statistical correlations used by the maintenance and service estimator module;
a transceiver configured to relay information from and to the maintenance and service review module and said plurality of vehicles; and
in-vehicle transceivers in said plurality of vehicles configured to transmit at least one of the collected information and derivatives of the collected information to the maintenance and service review module and to receive from the maintenance and service review module, one of new and updated statistical correlations;
wherein the maintenance and service review module is further configured to determine parts availability for the region, and order additional parts that are predicted to be needed in region such that inventory of parts meets predicted demand.

2. The system of claim 1, wherein vehicles of a common type comprise vehicles having a common make and model and one or more of the following characteristics in common:
equipment configuration,
age,
condition, and
mileage.

3. The system of claim 1 wherein the historical maintenance and services records comprise at least one of:
a maintenance or service item,
a location where the maintenance or service occurred,
time of maintenance or service,
vehicle parts replaced and repaired,
materials needed for service,
labor costs and material costs to effect service.

4. The system of claim 1, further comprising:
a maintenance parts and materials database housed in a memory of the maintenance and service review module containing an inventory of parts and maintenance items referenced by:
location;
applicable vehicles;
availability; and
cost;
wherein the maintenance and service review module is further configured to estimate time and cost of maintenance or service and the availability of parts and materials in the region of the plurality of vehicles—based on the predicted maintenance or service required as provided by the maintenance and service estimator module and transmitted by the in-vehicle transceiver.

5. The system of claim 1, wherein the maintenance and service prediction is transmitted using the in-vehicle transceiver to a mobile device or other device in possession of a driver of the vehicle or other authorized personnel.

6. The system of claim 1 further comprising an in-vehicle display screen wherein the estimate when maintenance and service needs to be performed are displayed on the display screen.

7. The system of claim 1 wherein the data collection module comprises at least one of an application on a mobile device operated by a driver or a service technician wherein the information is recorded automatically by the device or manually by the operator of the mobile device.

8. A method for scheduling vehicle service and estimating parts requirements for a plurality of vehicles operating within a region, comprising:
collecting information concerning operation of a plurality of vehicles of a common type operated in a region using in-vehicle data collection modules, including one or more sensors comprising at least one engine sensor and an accelerometer;
predicting when maintenance and parts are required for vehicles of the common type operating within the region, using a maintenance and service estimator module comprising a statistical predictive model based on statistical correlations of historical maintenance and service records, and historical information collected from said collection modules of said vehicles of the common type operated in the region, the historical information including engine sensor data and accelerometer data, when compared with current information collected from the plurality of said data collection modules;
estimating a demand for required parts within the region based on the predicted maintenance and parts requirements; and
comparing estimated demand for required parts within the region to parts inventories within the region and ordering additional parts for the region sufficient to meet the estimated demand.

9. The method of claim 8, further comprising:
one of determining and revising the statistical correlations used for predicting maintenance and service by relaying new information from said plurality of vehicles, using in-vehicle transceivers, to transmit, to the transceiver in communication with the maintenance and service review module, and incorporating the new information into the statistical correlations; and
transmitting one of new and updated statistical correlations to the plurality of vehicles.

10. The method of claim 8, further comprising:
configuring the maintenance and service review module to estimate time and cost of maintenance or service and the availability of parts and materials in the region of the plurality of vehicles based on the predicted maintenance and parts required as provided by the maintenance and service estimator module and transmitted by the in-vehicle transceiver; and
utilizing the maintenance and service review module further configured with a maintenance parts and materials database housed in a memory and containing an inventory of parts and maintenance items referenced by:
location;
applicable vehicles;
availability; and
cost.
